(19) United States
(12) Patent Application Publication
(10) Pub. No.: US 2025/0253626 A1
(43) Pub. Date: Aug. 7, 2025

(54) SEISMIC ISOLATION APPARATUS FOR ELECTRIC POWER EQUIPMENT HAVING FUNCTION OF ABSORBING VIBRATION IN WIDE RANGE AND EARTHQUAKE-PROOF DISTRIBUTING BOARD

(71) Applicant: YOUHO ELECTRIC IND. CO., LTD., Yangju-si (KR)

(72) Inventors: InChang YOU, Seoul (KR); KookChan HAN, Seoul (KR); TaeHo LEE, Uijeongbu-si (KR); SungHo LEE, Paju-si (KR); JinKun JUNG, Osan-si (KR); DaeJin CHOI, Yongin-si (KR)

(73) Assignee: YOUHO ELECTRIC IND. CO., LTD., Yangju-si (KR)

(21) Appl. No.: 18/947,157

(22) Filed: Nov. 14, 2024

(30) Foreign Application Priority Data
Feb. 1, 2024 (KR) 10-2024-0015939

(51) Int. Cl. H02B 1/54; H02B 1/01; H02B 1/30

(52) U.S. Cl. CPC H02B 1/54; H02B 1/303; H02B 1/014

(57) ABSTRACT

The present disclosure provides a seismic isolation apparatus for electric power equipment having a function of absorbing vibration in a wide range and an earthquake-proof distributing board, and an outer vertical spring is disposed in a vertical direction between an upper holder and a lower holder to be compressed or expanded according to a change in a vertical interval between the upper holder and the lower holder, and an inner vertical spring having an elastic coefficient greater than that of the outer vertical spring and a diameter smaller than that of the outer vertical spring is inserted into an inside of the outer vertical spring to be compressed or expanded according to a change 10 in a vertical interval between an upper cover and the upper holder, and thus, it is possible to smoothly absorb vertical vibrations whose intensity is distributed over a wide range, and to prevent the electric power equipment from falling by a center shaft that passes through the inner vertical spring, the outer vertical spring, and the upper holder in sequence.

### CROSS-REFERENCE TO RELATED APPLICATION

This application is based on and claims priority under 35 U.S.C. § 119 to Korean Patent Application No. 10-2024-0015939, filed on Feb. 1, 2024, in the Korean Intellectual Property Office, the disclosure of which is incorporated by reference herein in its entirety.

### BACKGROUND

### 1. Field

The present disclosure relates to a seismic isolation apparatus used for earthquake-proof of electric power equipment such as a distributing board and an earthquake-proof distributing board to which the electric power equipment is applied.

### 2. Description of the Related Art

A distributing board is an electric power equipment configured of distributing equipment such as circuit breakers, switches, and various instruments required for the distribution of electricity and control of a distribution system, and may be classified into high-voltage distributing boards, low-voltage distributing boards, motor control panels, and distributing boards. The distributing boards may break down or be damaged due to vibrations caused by earthquakes, or so on. For example, the fastening parts of the distributing equipment stored inside the distributing board may become loose, or the distributing board may fall over. In particular, when the distributing board falls over, the distribution board may be fired due to short circuits, or so on. Accordingly, research on earthquake-proof distributing boards has been actively conducted recently, and the earthquake-proof distributing boards are being installed and used in the field.

In order to prevent the earthquake of the distributing board, a seismic isolation apparatus is mainly used to block the vibration of a floor surface of a space where the distributing board is installed from being transmitted to the distributing board. Most of the seismic isolation apparatuses for distributing boards, such as Korean Patent No. 10-2305497 “EARTHQUAKE-RESISTANT AND VIBRATION ISOLATION APPARATUS FOR SWITCHGEAR” and Korean Patent No. 10-1834473 “The Distribution Board With Vibration isolation and Earthquake-proof Device”, use elastic bodies such as springs or rubber to absorb the vibration of the floor surface. Since the elasticity of rubber deteriorates significantly with age, springs are mostly used for vibration absorption these days.

The vibration of the floor surface due to earthquakes, surrounding construction, or so on is distributed over a very wide range of intensities. When strong vibration is applied to the distributing board, even when the strong vibration is applied temporarily, various components inside the distributing board may be damaged, so the springs of most distributing board seismic isolation apparatuses are designed to absorb strong vibrations. Springs designed to absorb strong vibrations cannot absorb weak vibrations because they do not compress when exposed to weak vibrations. When weak vibrations of the floor surface are transmitted as they are to the distributing board, they may affect various instruments that are very vulnerable to vibrations, and even weak vibrations may cause bolt loosening and other phenomena when the vibration continues repeatedly. Even for earthquake-proof distributing boards, the cumbersome maintenance work of periodically monitoring bolt loosening with the naked eye is still performed.

### SUMMARY

The present disclosure provides a seismic isolation apparatus for electric power equipment and a seismic distributing board having a wide-range vibration absorption function capable of smoothly absorbing various vibrations having a wide range of intensities while preventing electric power equipment from falling. The present disclosure is not limited to the technical tasks described above, and other technical tasks may be derived from the following description.

According to an aspect of the present disclosure, a seismic isolation apparatus for electric power equipment includes an upper holder disposed below a lower surface of a housing in which multiple electric power devices are stored; a lower holder disposed above a floor surface of a space where the housing is installed; an outer vertical spring formed in a form of a compression coil spring and disposed vertically between the upper holder and the lower holder to be compressed or expanded according to a change in a vertical gap between the upper holder and the lower holder; an inner vertical spring formed in a form of a compression coil spring having an elastic coefficient greater than that of the outer vertical spring and a diameter smaller than that of the outer vertical spring, and disposed vertically between the upper holder and the lower holder with a structure inserted into an inside of the outer vertical spring, and to be compressed or expanded according to the change in the vertical distance between the upper holder and the lower holder; and a center shaft a lower end is fixed to a center of the lower holder and disposed vertically with a structure that passes through the inner vertical spring, the outer vertical spring, and the upper holder in sequence.

A lower dome portion may be formed on a lower surface of the upper holder in a dome shape, a height of which may increase in the vertical direction toward the lower holder as going toward the center, and an upper end of the inner vertical spring may come into contact with the lower dome portion during a process in which the outer vertical spring (71) is compressed as a vertical gap between the upper holder (30) and the lower holder (60) narrows, and after the upper end of the inner vertical spring comes into contact with the lower dome portion, when the vertical gap between the upper holder and the lower holder gets narrower, the inner vertical spring may begin to be compressed.

A circular rail may be formed on the lower surface of the upper holder in a form that surrounds the lower dome portion, and an upper end of the outer vertical spring may be fitted into a groove between the lower dome portion and the circular rail on the lower surface of the upper holder, and an upper end of the inner vertical spring may be located to be spaced apart from the lower dome portion in a state where the outer vertical spring is expanded.

A center protrusion that protrudes in the vertical direction toward the upper holder in a shape of a circular plate, and an outer protrusion that protrudes in a form surrounding the center protrusion may be formed on an upper surface of the lower holder, and a lower end of the outer vertical spring may be fitted into a groove between the center protrusion and the outer protrusion, and a lower end of the inner vertical spring may be fitted into a center groove formed on an upper surface of the center protrusion.

The seismic isolation apparatus for electric power equipment may further include an upper cover formed in a cross-section of “[” shape that is open at the lower side; and multiple outer horizontal springs that are each formed in a form of a compression coil spring and are disposed in the horizontal direction between the upper cover and the upper holder to be compressed or expanded according to a change in a horizontal gap between the upper cover and the upper holder, in which the upper holder may be formed in a cylindrical shape and may be disposed in an inner space of the upper cover.

The seismic isolation apparatus for electric power equipment may further include multiple inner horizontal springs that are each formed in a form of a compression coil spring having an elastic coefficient greater than that of each outer horizontal spring and a diameter smaller than that of each outer horizontal spring, and is disposed between the upper cover and the upper holder in horizontal direction with a structure that is inserted into the inside of each of the multiple outer horizontal springs to be compressed or expanded according to a change in a horizontal gap between the upper cover and the upper holder.

Multiple horizontal protrusions may be formed on an inner surface of the upper cover at regular intervals to protrude in the horizontal direction toward the upper holder, and one end of at least one inner horizontal spring may come into contact with the at least one horizontal protrusion during a process in which at least one outer horizontal spring among the multiple outer horizontal springs is compressed as a gap between at least one horizontal protrusion (201) among the multiple horizontal protrusions (201) and the upper holder (30) narrows, after one end of the at least one inner horizontal spring comes into contact with the at least one horizontal protrusion, when a gap between the at least one horizontal protrusion and the upper holder gets narrower, the at least one inner vertical spring may begin to be compressed.

One end of each of the multiple outer horizontal springs may be fitted around each of the multiple horizontal protrusions, and one end of each of the multiple inner vertical springs may be located to be spaced apart from each of the multiple horizontal protrusions in a state where each of the multiple outer horizontal springs is expanded.

Multiple stepped grooves may be formed on an outer surface of the upper holder, each of which may have an outer groove that is sunken opposite to the direction toward each of the multiple horizontal protrusions and an inner groove in a format that bottom surface center of the outer groove is sunken, and the other end of each of the multiple outer horizontal springs may be fitted into the outer groove of each of the multiple step grooves, and the other end of each of the multiple inner horizontal springs may be fitted into the inner groove of each of the multiple step grooves.

The seismic isolation apparatus for electric power equipment may further include a ball slider 40 that horizontally slides in a state of coming into contact with an inner surface of the upper cover, using multiple balls that make rolling motions by coming into contact with a lower surface of the upper cover, wherein the ball slider may be attached to the upper surface of the upper holder to allow the upper holder to slide horizontally inside the upper cover according to the compression or expansion of the multiple outer horizontal springs.

A center hole may be formed in the center of the lower holder such that a diameter of the center hole gets narrower toward an upper sided of the center hole, and the center shaft may be formed in the shape of a countersunk bolt and a countersunk portion corresponding to a lower end may be fitted into the center hole such that the center shaft may be fixed to the center of the lower holder.

According to another aspect of the present disclosure, an earthquake-proof distributing board includes a housing in which multiple distribution devices are stored; and the seismic isolation apparatus for electric power equipment, which is installed between the lower surface of the housing and the floor surface of the space in which the housing is installed.

The outer vertical spring is disposed in the vertical direction between the upper holder and the lower holder to be compressed or expanded according to the change in the vertical interval between the upper holder and the lower holder, and the inner vertical spring having the elastic coefficient greater than that of the outer vertical spring and the diameter smaller than that of the outer vertical spring has a structure of inserting into the inside of the outer vertical spring to be compressed or expanded according to the change in the vertical interval between the upper cover and the upper holder, such that it is possible to smoothly absorb vertical vibrations whose intensity is distributed over a wide range.

When the outer vertical spring and the inner vertical spring are bent due to an external impact such as an earthquake, a large electric power equipment such as a distributing board may tilt and fall over. The center shaft having a lower end fixed to the center of the lower holder and is disposed vertically with a structure that passes through the inner vertical spring, the outer vertical spring, and the upper holder in sequence, may prevent the outer vertical spring and the inner vertical spring from being bent due to an external impact such as an earthquake, and as a result, the electric power equipment may be prevented from falling over due to an external impact such as an earthquake.

Multiple outer horizontal springs are disposed horizontally between the upper cover and the upper holder, and are compressed or expanded according to the change in the horizontal gap between the upper cover and the upper holder, and multiple inner horizontal springs having the elastic coefficient greater than that of each outer horizontal spring and the diameter smaller than that of each outer horizontal spring are inserted into each of the multiple outer horizontal springs to be compressed or expanded according to the change in the horizontal gap between the upper cover and the upper holder, such that it is possible to smoothly absorb horizontal vibrations whose intensity is distributed over a wide range.

The vertical vibrations of various intensities may be absorbed by the interlocking vibration absorption structure of the outer vertical spring and the inner vertical spring, and horizontal vibrations of various intensities may be absorbed by the interlocking vibration absorption structure of the multiple outer horizontal springs and the multiple inner horizontal springs, such that various three-dimensional omnidirectional vibrations whose intensities are distributed over a wide range may be absorbed smoothly. The effects are not limited to the effects described above, and other effects may be derived from the following description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exemplary view of an earthquake-proof distributing board according to one embodiment of the present disclosure;

FIGS. 2 and 3 are longitudinal cross-sectional views of a seismic isolation module 100 illustrated in FIG. 1;

FIG. 4 is an exploded view of the seismic isolation module 100 illustrated in FIG. 1;

FIG. 5 is a view illustrating an outer vertical spring 71 of FIGS. 2 to 4 in a compressed state;

FIG. 6 is a view illustrating an inner vertical spring 72 of FIGS. 2 to 4 in a compressed state;

FIG. 7 is a view illustrating a right outer horizontal spring 51 of FIGS. 2 to 4 in a compressed state;

FIG. 8 is a view illustrating a right inner horizontal spring 52 of FIGS. 2 to 4 in a compressed state;

FIG. 9 is a view illustrating a left outer horizontal spring 51 of FIGS. 2 to 4 in a compressed state; and

FIG. 10 is a view illustrating a left inner horizontal spring 52 of FIGS. 2 to 4 in a compressed state.

### DETAILED DESCRIPTION

Hereinafter, embodiments of the present disclosure will be described in detail with reference to the drawings. The embodiments of the present disclosure to be described below relate to a seismic isolation apparatus for electric power equipment having function of absorbing vibration in wide range capable of smoothly absorbing various vibrations having a wide range of intensities while preventing electric power equipment from falling, and an earthquake-proof distributing board to which the seismic isolation apparatus for electric power equipment is applied. Hereinafter, the seismic isolation apparatus for electric power equipment and the seismic distributing board may be simply referred to as “seismic isolation apparatus” and “distributing board.”

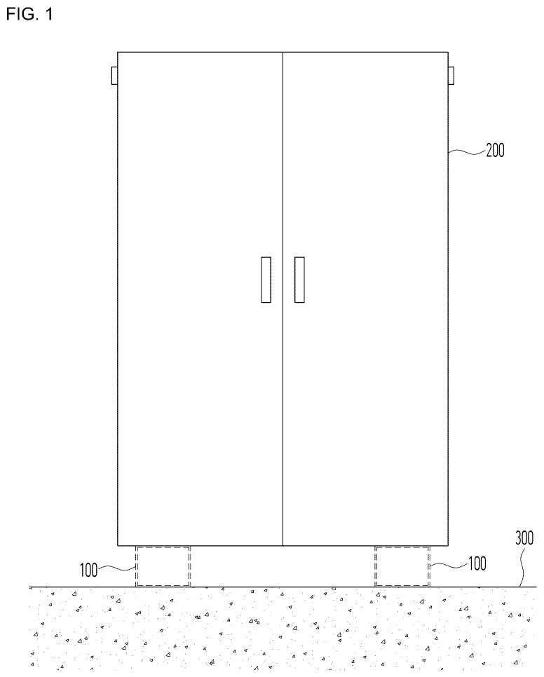

FIG. 1 is an exemplary view of an earthquake-proof distributing board according to one embodiment of the present disclosure. The electric power equipment is generally configured of a housing 200 and multiple electric power devices housed inside the housing 200. The electric power equipment and the electric power device may also be referred to as electric power equipment and electrical device. FIG. 1 illustrates an earthquake-proof distributing board as a representative example of an earthquake-proof electric power equipment according to the present embodiment. Referring to FIG. 1, the earthquake-proof distributing board according to the present embodiment consists of the housing 200 in which multiple distribution devices (not illustrated) are housed, and a seismic isolation apparatus 100 installed between a lower surface of the housing 200 and a floor surface 300 of a space in which the housing 200 is installed to block vibration of the floor surface 300 from being transmitted to the housing 200. The distribution device refers to an electric power device used for power distribution. The seismic isolation apparatus 100 of the present embodiment is configured of multiple seismic isolation modules 100. For example, the seismic isolation apparatus 100 may be configured of four seismic isolation modules 100.

The housing 200 is formed in a large square box shape and is installed on the floor surface 300 such as a concrete floor surface 300 or the ground inside a building, and multiple distributing equipment such as a transformer, a circuit breaker, a switch, and various instruments are stored inside it. As illustrated in FIG. 1, the housing 200 may be formed in a cabinet structure that may be opened and closed for inspection of the distribution device. In order to block vibrations of the floor surface 300 caused by an earthquake, surrounding construction, or so on from being transmitted to the housing 200 while stably supporting the housing 200, four seismic isolation modules 100 are each inserted between the four corners of the lower surface of the housing 200 and the floor surface 300 of the space where the housing 200 is installed.

The distributing board may include only one housing 200 or may include multiple housings 200 disposed in a row. In a case where the distributing board includes the multiple housings 200, a square plate is attached to each of the upper and lower surfaces of the multiple housings 200 such that the multiple housings 200 may function as one unit against an external force. In this case, four seismic isolation modules 100 are inserted between each of the four corner portions of the square plate attached to the lower surfaces of the multiple housings 200 and the floor surface 300 on which the housings 200 are installed.

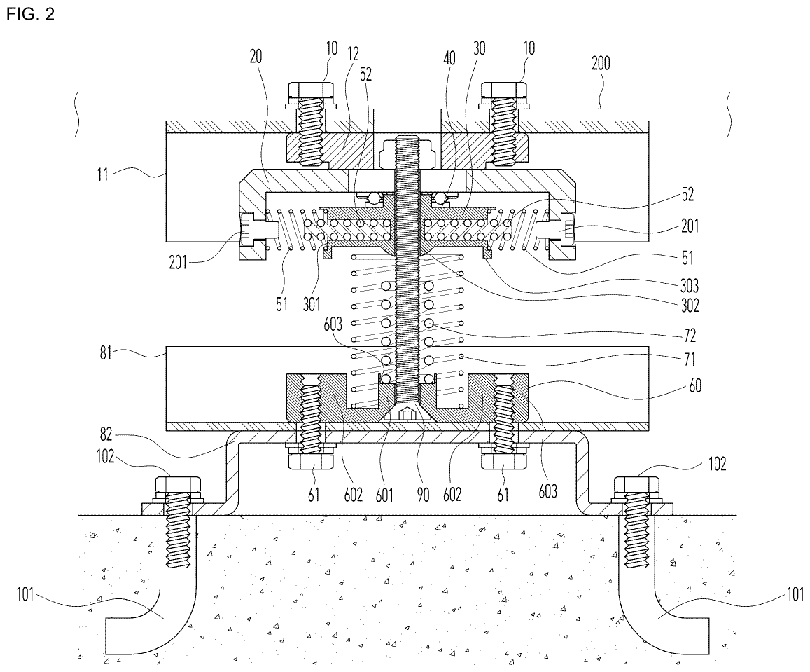

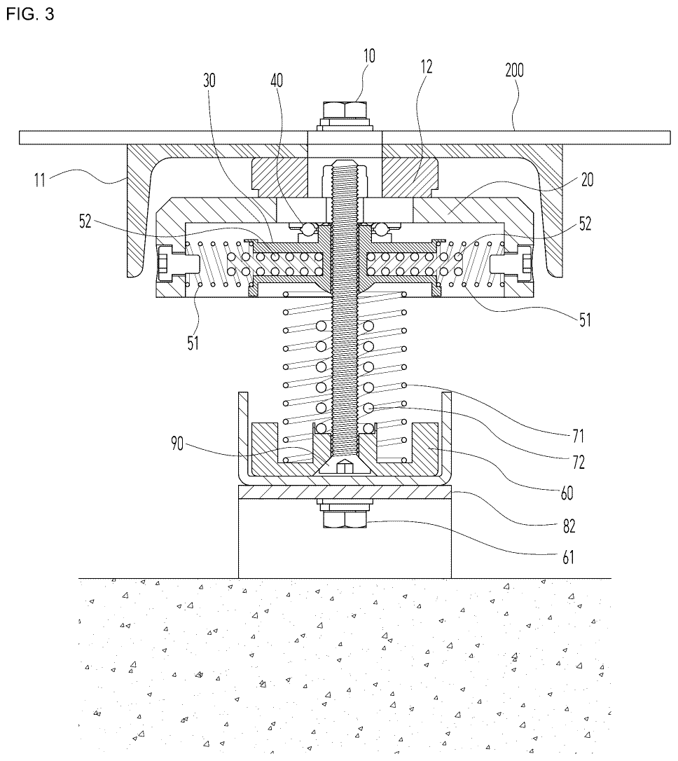

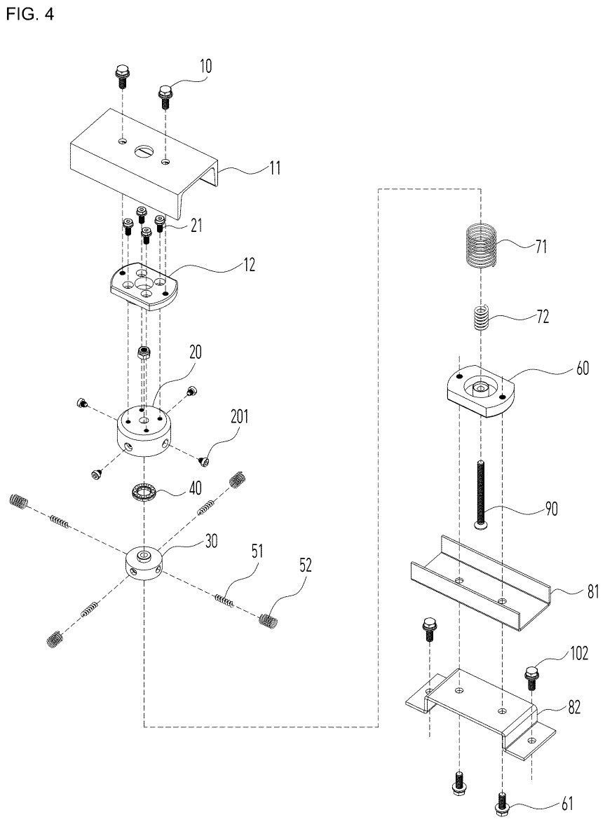

FIGS. 2 and 3 are longitudinal cross-sectional views of the seismic isolation module 100 illustrated in FIG. 1, and FIG. 4 is an exploded view of the seismic isolation module 100 illustrated in FIG. 1. FIG. 2 is a longitudinal cross-sectional view of each seismic isolation module 100 illustrated in FIG. 1 as viewed from the front of the distributing board, and FIG. 3 is a longitudinal cross-sectional view of each seismic isolation module 100 illustrated in FIG. 1 as viewed from the right side of the distributing board. Referring to FIGS. 2 to 4, each seismic isolation module 100 is configured of an upper bracket 11, an upper plate 12, an upper cover 20, an upper holder 30, a ball slider 40, multiple outer horizontal springs 51, multiple inner horizontal springs 52, a lower holder 60, an outer vertical spring 71, an inner vertical spring 72, a lower bracket 81, a lower support 82, and a center shaft 90.

In the embodiment illustrated in FIGS. 2 to 4, the multiple outer horizontal springs 51 and the multiple inner horizontal springs 52 are configured of four outer horizontal springs 51 and four inner horizontal springs 52. The multiple outer horizontal springs 51 and the multiple inner horizontal springs 52 may be configured of different numbers of outer horizontal springs 51 and inner horizontal springs 52. For example, the multiple outer horizontal springs 51 and the multiple inner horizontal springs 52 may be configured of six outer horizontal springs 51 and six inner horizontal springs 52, or may be configured of eight outer horizontal springs 51 and eight inner horizontal springs 52.

The upper bracket 11 is formed in a U-shaped steel with an open lower side, and is disposed between the housing 200 and the upper plate 12 such that flanges on both sides of the upper bracket 11 are located at the front and rear sides. A center hole corresponding to a passage of the center shaft 90 is formed at the center of the web of the upper bracket 11, and two bolt holes penetrating in the thickness direction are formed on the left and right sides of the center hole. The upper bracket 11 and the lower bracket 81 serve to protect key components of each seismic isolation module 100 disposed between the upper bracket 11 and the lower bracket 81, such as the upper cover 20, the upper holder 30, the multiple outer horizontal springs 51, the multiple inner horizontal springs 52, the lower holder 60, the outer vertical spring 71, and the inner vertical spring 72, from external impact.

The upper plate 12 is formed in an oval plate shape and is placed between the housing 200 and the upper cover 20. The upper plate 12 may be formed in various plate shapes such as a circular plate, a square plate, and an octagonal plate. A center hole corresponding to the passage of the center shaft 90 is formed in the center of the upper plate 12, and four bolt holes penetrating in the thickness direction are formed at 90-degree intervals around the center hole, and two bolt holes penetrating in the thickness direction are formed on the left and right edges thereof.

The two bolt holes formed on the left and right edges of the upper plate 12 are used for connection with the housing 200 and the upper bracket 11, and the four bolt holes formed around the center hole are used for connection with the upper cover 20. The two bolts 10 pass through the two bolt holes of the lower plate of the housing 200 and the two bolt holes of the upper bracket 11 in sequence, and then are fastened to the bolt holes of the left and right edges of the upper plate 12, such that the upper bracket 11 and the upper plate 12 are tightly fastened to the lower plate of the housing 200. The two bolt holes formed on the left and right edges of the upper plate 12 have nut threads formed on the inner peripheral surface thereof such that the two bolts 10 may be fastened.

The upper cover 20 is formed in a cylindrical shape with a cross-section of “[” that is open at the lower side and is disposed between the upper plate 12 and the upper holder 30. The upper cover 20 may also be formed in other shapes such as a square cylinder and an octagonal cylinder with a cross-section of “[” that is open at the lower side. Four bolt holes penetrating in the thickness direction are formed at 90-degree intervals on the upper surface of the upper cover 20. The four bolts 21 pass through the four bolt holes formed around the center hole of the upper plate 12 and then are fastened to the four bolt holes formed on the upper surface of the upper cover 20, such that the upper surface of the upper cover 20 is tightly coupled to the lower surface of the upper plate 12. The four bolt holes formed on the upper surface of the upper cover 20 have nut threads formed on the inner peripheral surface thereof such that the four bolts 21 may be fastened.

On the inner peripheral surface of the upper cover 20, multiple horizontal protrusions 201 are formed at regular intervals so as to protrude in a horizontal direction toward the outer peripheral surface of the upper holder 30. In the embodiment illustrated in FIGS. 2 to 4, four horizontal protrusions 201 are formed at 90-degree intervals on the inner peripheral surface of the upper cover 20. The horizontal vibration applied to each seismic isolation module 100 may be vibration in a direction other than the four directions of front, back, left, and right. In order to ensure that the horizontal vibration applied to each seismic isolation module 100 may be absorbed smoothly, a greater number of horizontal protrusions 201 may be formed on the inner peripheral surface of the upper cover 20. In an example where the number of outer horizontal springs 51 and inner horizontal springs 52 is eight, eight horizontal protrusions 201 may be formed at 45-degree intervals on the inner peripheral surface of the upper cover 20.

An end of each horizontal protrusion 201 formed on the inner peripheral surface of the upper cover 20 may be formed in a dome shape whose height increases in the horizontal direction toward the outer peripheral surface of the upper holder 30 as it gets closer to the center of the horizontal protrusion 201. In a state where no external force is applied to each seismic isolation module 100, each inner horizontal spring 52 of the present embodiment is disposed inside each outer horizontal spring 51 such that one end thereof is not fixed to any groove or so on, but is located to be spaced apart from the end of each horizontal protrusion 201 formed on the inner peripheral surface of the upper cover 20. For the reason described in detail below with respect to the lower dome portion 302 formed on the lower surface of the upper holder 30, when vibration due to an earthquake is applied to each seismic isolation module 100, each inner horizontal spring 52 may bend in any direction. At this time, the opening of one end of the inner vertical spring 72 forms a surface that is somewhat inclined with respect to the outer peripheral surface of the upper holder 30.

Since the end of each horizontal protrusion 201 formed on the inner peripheral surface of the upper cover 20 is formed in a dome shape whose height increases in the horizontal direction toward the outer peripheral surface of the upper holder 30 as it gets closer to the center of the horizontal protrusion 201, even when the upper end opening surface of the inner horizontal spring 52 is inclined with respect to the outer peripheral surface of the upper holder 30, the inner horizontal spring 52 is guided to an upright shape. That is, when the inner horizontal spring 52 is fitted into the horizontal protrusion 201 starting from a part of the edge of the inner horizontal spring 52 that comes into contact first, the inner horizontal spring 52 returns to the upright shape even when the inner horizontal spring 52 is bent. Accordingly, the inner horizontal spring 52 may smoothly absorb the horizontal vibration component of the vibration of the bottom surface 300.

Each horizontal protrusion 201 formed on the inner peripheral surface of the upper cover 20 may be implemented as a bolt whose end is formed in a rounded dome shape. Four bolt holes to which four horizontal protrusions 201 may be fastened are formed on the inner peripheral surface of the upper cover 20, such that four horizontal protrusions 201 may be protruded and formed on the inner peripheral surface of the upper cover 20 by fastening the four horizontal protrusions 201 to the four bolt holes. As illustrated in FIGS. 2 to 4, a diameter of the inner horizontal spring 52 is much smaller than that of the inner vertical spring 72. Accordingly, unlike the lower dome portion 302 formed on the lower surface of the upper holder 30, the upright inducing effect of the inner horizontal spring 52 due to the dome shape of the end of each horizontal protrusion 201 may be minimal. Depending on the diameter size of the inner horizontal spring 52, the end of each horizontal protrusion 201 may be formed flat to easily form each horizontal protrusion 201.

The upper holder 30 is formed in a cylindrical shape and is disposed in the inner space of the upper cover 20. The upper holder 30 may also be formed in a polygonal cylindrical shape, such as a square cylindrical shape or an octagonal cylindrical shape. A center hole corresponding to the passage of the center shaft 90 is formed in the center of the upper holder 30, and the lower dome portion 302 is formed in the center of the lower surface of the upper holder 30 in a dome shape, the height of which increases downwardly as it gets closer to the center of the lower surface, that is, in the vertical direction toward the lower holder 60. A circular rail 303 is formed on the lower surface of the upper holder 30 in a form that surrounds the lower dome portion 302. The circular rail 303 on the lower surface of the upper holder 30 is located at the lower edge of the upper holder 30.

As illustrated in FIG. 2, the cross-section of the lower dome portion 302 has a crescent shape. When an earthquake occurs, the P wave arrives at the ground surface and then the S wave arrives. When the floor surface 300 of the space where the distributing board housing 200 is installed vibrates due to the earthquake, an external force in a random direction is irregularly applied to each seismic isolation module 100 due to the characteristics of the seismic wave and various terrains.

In a state where there is no external force applied to each seismic isolation module 100, the inner vertical spring 72 of the present embodiment is disposed inside the outer vertical spring 71 such that an upper end of the inner vertical spring 72 is not fixed to any groove or so on and is located apart from the lower dome portion 302 formed on the lower surface of the upper holder 30. When vibration due to an earthquake is applied to each seismic isolation module 100, the inner vertical spring 72 cannot always be in the upright shape as illustrated in FIG. 2 and may bend in an arbitrary direction. At this time, the upper end opening surface of the inner vertical spring 72 forms a surface that is somewhat inclined with respect to the horizontal plane corresponding to the virtual lower surface of the upper holder 30. Here, the virtual lower surface of the upper holder 30 means a surface when the lower surface of the upper holder 30 is assumed to be flat, identical to the upper surface of the upper holder 30.

The lower dome portion 302 formed on the lower surface of the upper holder 30 has a shape in which the height increases in the vertical direction toward the lower holder 60 as it gets closer to the center, such that even when the upper end opening surface of the inner vertical spring 72 is inclined with respect to the horizontal plane, the lower dome portion 302 plays a role in inducing the inner vertical spring 72 to be in the upright shape. That is, when the inner vertical spring 72 is fitted into the lower dome portion 302 starting from the part of the upper edge of the inner vertical spring 72 that comes into contact first, the inner vertical spring 72 returns to the upright shape even when the inner vertical spring 72 is bent. Accordingly, the inner vertical spring 72 may smoothly absorb the vertical vibration component of the vibration of the bottom surface 300.

On the outer peripheral surface of the upper holder 30, multiple stepped grooves 301 are formed at regular intervals, each of which has an outer groove that is sunken opposite to the direction toward each of the multiple horizontal protrusions 201 of the upper cover 20 and an inner groove in a form that bottom surface center of the outer groove is sunken. In the embodiment illustrated in FIGS. 2 to 4, four stepped grooves 301 are formed at 90-degree intervals on the outer peripheral surface of the upper holder 30. As described above, a greater number of stepped grooves 301 may be formed on the outer peripheral surface of the upper holder 30 such that the horizontal vibration applied to each seismic isolation module 100 may be absorbed smoothly. In an example where the number of outer horizontal springs 51 and inner horizontal springs 52 is eight, eight stepped grooves 301 may be formed at 45-degree intervals on the outer peripheral surface of the upper holder 30.

The ball slider 40 uses multiple balls that make rolling motions by coming into contact with the lower surface of the upper cover 20 to horizontally slide in a state of coming into contact with the inner surface of the upper cover 20. The ball slider 40 is attached to the upper surface of the upper holder 30 to allow the upper holder 30 to slide horizontally inside the upper cover 20 according to the compression or expansion of four outer horizontal springs 51 disposed between the inner peripheral surface of the upper cover 20 and the outer peripheral surface of the upper holder 30. When the four inner horizontal springs 52 are compressed or expanded together with the compression or expansion of the four outer horizontal springs 51, the ball slider 40 allows the upper holder 30 to slide horizontally inside the upper cover 20 according to the compression or expansion of the four inner horizontal springs 52.

Due to the weight of the distributing board, a downward force is always applied to the upper plate 12. The ball slider 40 allows the upper holder 30 to slide horizontally with almost no friction inside the upper cover 20, which is always pressed down by the weight of the distributing board through the upper plate 12. The ball slider 40 may be implemented with multiple balls, a ring-shaped cage that maintains the spacing between the multiple balls, and a ring-shaped ball mounting plate on which the multiple balls are mounted, as illustrated in FIGS. 2 to 4. The ball slider 40 is attached and fixed to the upper surface of the upper holder 30 by having the ball mounting plate fitted into a disc-shaped protrusion formed on the upper surface of the upper holder 30.

The multiple outer horizontal springs 51 are each formed in the form of a compression coil spring and are disposed at certain intervals in the horizontal direction between the inner peripheral surface of the upper cover 20 and the outer peripheral surface of the upper holder 30. The outer horizontal springs 51 are compressed or expanded according to the change in the horizontal interval between the inner peripheral surface of the upper cover 20 and the outer peripheral surface of the upper holder 30, thereby absorbing the horizontal vibration component of the vibration of the floor surface 300 caused by an earthquake, surrounding construction work, or so on. In the embodiment illustrated in FIGS. 2 to 4, four outer horizontal springs 51 are disposed at 90-degree intervals between the inner peripheral surface of the upper cover 20 and the outer peripheral surface of the upper holder 30. The four outer horizontal springs 51 are disposed at certain intervals between the inner peripheral surface of the upper cover 20 and the outer peripheral surface of the upper holder 30, with each end fitted around each of the four horizontal protrusions 201 formed on the inner peripheral surface of the upper cover 20 and the other end fitted into each of the four outer grooves 301 formed on the outer peripheral surface of the upper holder 30.

The four outer horizontal springs 51 may effectively damp the vibration components in the x-axis direction, which is the left-right direction, and the vibration components in the y-axis direction, which is the front-back direction, among the horizontal vibration components applied to each seismic isolation module 100. In an example where the number of outer horizontal springs 51 is eight, eight outer horizontal springs 51 may be disposed at 45-degree intervals between the inner peripheral surface of the upper cover 20 and the outer peripheral surface of the upper holder 30. The eight outer horizontal springs 51 may effectively damp the two diagonal vibration components between the x-axis and the y-axis, as well as the vibration components in the x-axis direction and the y-axis direction.

The multiple inner horizontal springs 52 are each formed in the form of a compression coil spring and are disposed at certain intervals in the horizontal direction between the inner peripheral surface of the upper cover 20 and the outer peripheral surface of the upper holder 30. The inner horizontal springs 52 are compressed or expanded according to the change in the horizontal interval between the inner peripheral surface of the upper cover 20 and the outer peripheral surface of the upper holder 30, thereby absorbing the horizontal vibration component of the vibration of the floor surface 300 caused by an earthquake, surrounding construction work, or so on. In particular, each inner horizontal spring 52 is formed in the form of a compression coil spring having an elastic coefficient greater than that of each outer horizontal spring 51 and a diameter smaller than that of each outer horizontal spring 51, and is inserted into the inside of each outer horizontal spring 51 and is disposed between the inner peripheral surface of the upper cover 20 and the outer peripheral surface of the upper holder 30, and is compressed or expanded according to changes in the horizontal gap between the inner peripheral surface of the upper cover 20 and the outer peripheral surface of the upper holder 30.

In the embodiment illustrated in FIGS. 2 to 4, each of four inner horizontal springs 52 is inserted into each of four outer horizontal springs 51 disposed at 90-degree intervals between the inner peripheral surface of the upper cover 20 and the outer peripheral surface of the upper holder 30. Each of the four inner vertical springs 72 has one end that is located to be spaced apart from each of the four horizontal protrusions 201 formed on the inner peripheral surface of the upper cover 20 in the expanded state of each of the four outer horizontal springs 51, and the other end that is inserted into each of the four outer horizontal springs 51 in a structure where each of the four ends is fitted into each of the four stepped grooves 301 formed on the outer peripheral surface of the upper holder 30. Here, the expanded state of each of the four outer horizontal springs 51 means the expanded state of each of the four outer horizontal springs 51 in a state where there is no horizontal vibration of the floor surface 300. The wire thickness and material of the outer horizontal spring 51 and the inner horizontal spring 52 may be designed so as to have an elastic modulus and diameter suitable for the present embodiment.

Since each outer horizontal spring 51 has the elastic coefficient smaller than that of each inner horizontal spring 52, when the horizontal vibration of the floor surface 300 on which the distributing board is installed is strong, each outer horizontal spring 51 may be completely compressed. In this case, each outer horizontal spring 51 cannot absorb the strong vibration of the ground on which the distributing board is installed, and the strong horizontal vibration of the floor surface 300 on which the distributing board is installed is transmitted to the distributing board as is. When strong vibration is applied to the distributing board, even when the strong vibration is applied temporarily, various types of components inside the distributing board may be damaged, so most springs of the seismic isolation apparatus for distributing board are designed to absorb strong vibration.

Since each inner horizontal spring 52 has the elastic coefficient greater than that of each outer horizontal spring 51, each inner horizontal spring 52 may not be compressed when the intensity of horizontal vibration of the floor surface 300 on which the distributing board is installed is weak. In this case, each inner horizontal spring 52 cannot absorb the weak horizontal vibration of the floor surface 300 on which the distributing board is installed, and the weak horizontal vibration of the floor surface 300 on which the distributing board is installed is transmitted to the distributing board as is. Various instruments that are highly vulnerable to vibration are installed inside the distributing board, and even when the vibration is weak, when the vibration continues repeatedly, phenomena such as bolt loosening may occur.

When horizontal vibration is applied to each seismic isolation module 100, the gap between the end of at least one horizontal protrusion 201 among the four horizontal protrusions 201 formed on the inner peripheral surface of the upper cover 20 and the outer peripheral surface of the upper holder 30 narrows. As the gap between the end of at least one horizontal protrusion 201 among the four horizontal protrusions 201 formed on the inner peripheral surface of the upper cover 20 and the outer peripheral surface of the upper holder 30 narrows, at least one outer horizontal spring 51 fitted into at least one horizontal protrusion 201 among the four outer horizontal springs 51 is compressed. During the process in which at least one outer horizontal spring 51 is compressed, one end of at least one inner horizontal spring 52 inserted into the inside of at least one outer horizontal spring 51 may come into contact with the end of at least one horizontal protrusion 201. After one end of at least one inner horizontal spring 52 comes into contact with the end of at least one horizontal protrusion 201, when the gap between the end of at least one horizontal protrusion 201 and the outer peripheral surface of the upper holder 30 gets narrower, at least one inner horizontal spring 52 begins to be compressed.

According to the present embodiment, for a change in the horizontal distance between the inner peripheral surface of the upper cover 20 and the outer peripheral surface of the upper holder 30 due to a weak horizontal vibration among the vibrations of the floor surface 300 on which the distributing board is installed, the weak horizontal vibration among the vibrations of the floor surface 300 on which the distributing board is installed may be absorbed by compressing or expanding at least one of the four outer horizontal springs 51, and for a change in the horizontal distance between the inner peripheral surface of the upper cover 20 and the outer peripheral surface of the upper holder 30 due to a strong horizontal vibration among the vibrations of the floor surface 300 on which the distributing board is installed, the strong horizontal vibration among the vibrations of the floor surface 300 on which the distributing board is installed may be absorbed by compressing or expanding at least one of the four outer horizontal springs 51 and at least one inner horizontal spring 52 inserted into the inside of the at least one outer horizontal spring 51 together. As a result, each seismic isolation module 100 may smoothly absorb horizontal vibrations with a wide intensity range.

The lower holder 60 has a structure which is formed in the shape of an oval plate and is disposed on the lower bracket 81, and is disposed on the floor surface 300 of the space where the housing 200 is installed. The lower holder 60 may be formed in various plate shapes such as a circular plate, a square plate, and an octagonal plate. A center protrusion 601 is formed in the center of the upper surface of the lower holder 60 in the shape of a circular plate and protrudes upward, i.e., in a vertical direction toward the upper holder 30, and an outer protrusion 602 is formed around a center protrusion 601 and protrudes in a form that surrounds the center protrusion 601. Two bolt holes are formed on the left and right sides of the outer protrusion 602 that penetrate in the thickness direction.

On the upper surface of the center protrusion 601, a center groove 603 is formed in a sunken shape in the lower direction, that is, the opposite direction of the upper holder 30 in the vertical direction, and a center hole is formed in the center of the bottom surface of the center groove 603 to penetrate the center protrusion 601 in the thickness direction. The center groove 603 formed in the center of the lower holder 60, that is, the center of the center protrusion 601, is used to fix the lower end of the inner vertical spring 72, and the center hole is used to fix the lower end of the center shaft 90.

The outer vertical spring 71 is formed in the form of a compression coil spring and is disposed in the vertical direction between the upper holder 30 and the lower holder 60. The outer vertical spring 71 is compressed or expanded according to the change in the vertical interval between the upper holder 30 and the lower holder 60, thereby absorbing the vertical vibration component of the vibration of the floor surface 300 caused by an earthquake, surrounding construction work, or so on. Un upper end of the outer vertical spring 71 is fitted into the groove between the lower dome portion 302 and the circular rail 303 on the lower surface of the upper holder 30, and a lower end fitted into the groove between the center protrusion 601 and the outer protrusion 602 on the upper surface of the lower holder 60. The outer vertical spring 71 is disposed vertically between the upper holder 30 and the lower holder 60. The outer vertical spring 71 may effectively attenuate the vibration component in the z-axis direction, which is the vertical direction, among the vibrations applied to each seismic isolation module 100.

The inner vertical spring 72 is formed in the form of a compression coil spring and is disposed in the vertical direction between the upper holder 30 and the lower holder 60. The inner vertical spring 72 is compressed or expanded according to the change in the vertical interval between the upper holder 30 and the lower holder 60, thereby absorbing the vertical vibration component of the vibration of the floor surface 300 caused by an earthquake, surrounding construction work, or so on. In particular, the inner vertical spring 72 is formed in the form of a compression coil spring having an elastic coefficient greater than that of the outer vertical spring 71 and a diameter smaller than that of the outer vertical spring 71, and is inserted into the inside of the outer vertical spring 71 and is disposed between the upper cover 20 and the upper holder 30, and is compressed or expanded according to changes in the vertical gap between the upper cover 20 and the upper holder 30.

An upper end of the inner vertical spring 72 is located to be spaced apart from the lower dome portion 302 formed on the lower surface of the upper holder 30 in a state where the outer vertical spring 71 is expanded, and a lower end that is fitted into the center groove 603 formed on the upper surface of the center protrusion 601 of the lower holder 60 and mounted on the center protrusion 601 to be inserted into the inside of the outer vertical spring 71. Here, the expanded state of the outer vertical spring 71 means the expanded state of the outer vertical spring 71 in a state where there is no vertical vibration of the floor surface 300. The wire thickness and material of the outer vertical spring 71 and the inner vertical spring 72 may be designed so as to have an elastic modulus and diameter suitable for the present embodiment.

Since the outer vertical spring 71 has the elastic coefficient smaller than that of the inner vertical spring 72, the outer vertical spring 71 may be completely compressed when the vertical vibration of the floor surface 300 on which the distributing board is installed is strong. In this case, the outer vertical spring 71 cannot absorb the strong vertical vibration of the floor surface 300 on which the distributing board is installed, and the strong vertical vibration of the ground on which the distributing board is installed is transmitted to the distributing board as is. As described above, when strong vibration is applied to the distributing board, even when the string vibration is applied temporarily, various types of components inside the distributing board may be damaged, and therefore, the springs of most seismic isolation apparatuses for distributing boards are designed to absorb strong vibrations.

Since the inner vertical spring 72 has the elastic coefficient greater than that of the outer vertical spring 71, the inner vertical spring 72 may not be compressed when the vertical vibration of the floor surface 300 on which the distributing board is installed is weak. In this case, the inner vertical spring 72 cannot absorb the weak vertical vibration of the floor surface 300 on which the distributing board is installed, and the weak vertical vibration of the floor surface 300 on which the distributing board is installed is transmitted to the distributing board as is. As described above, not only are various instruments that are highly vulnerable to vibration installed inside the distributing board, but even when the vibration is weak, when the vibration continues repeatedly, phenomena such as bolt loosening may occur.

When the vertical vibration is applied to each seismic isolation module 100, the vertical gap between the upper holder 30 and the lower holder 60 narrows. As the vertical gap between the upper holder 30 and the lower holder 60 narrows, the outer vertical spring 71 is compressed. During the process in which the outer vertical spring 71 is compressed, the upper end of the inner vertical spring 72 may come into contact with the lower dome portion 302. After the upper end of the inner vertical spring 72 comes into contact with the lower dome portion 302, when the vertical gap between the upper holder 30 and the lower holder 60 gets narrower, the inner vertical spring 72 begins to be compressed.

According to the present embodiment, for the change in the vertical distance between the upper holder 30 and the lower holder 60 due to a weak vertical vibration among the vibrations of the floor surface 300 on which the distributing board is installed, the outer vertical spring 71 is compressed or expanded, thereby absorbing the weak vertical vibration among the vibrations of the floor surface 300 on which the distributing board is installed, and for the change in the vertical distance between the upper holder 30 and the lower holder 60 due to a strong vertical vibration among the vibrations of the floor surface 300 on which the distributing board is installed, the outer vertical spring 71 and the inner vertical spring 72 inserted into the inside of the outer vertical spring 71 are compressed or expanded together, thereby absorbing the strong vertical vibration among the vibrations of the floor surface 300 on which the distributing board is installed. As a result, each seismic isolation module 100 may smoothly absorb vertical vibrations whose intensity is distributed over a wide range.

The lower bracket 81 is formed in a U-shaped steel with an open upper side and is disposed between the lower holder 60 and the lower support 82 such that two flanges of the lower support 82 are located at the front and rear sides. Two bolt holes are formed on the left and right sides of the web of the lower bracket 81 to penetrate the web in the thickness direction. The lower bracket 81, together with the upper bracket 11, serves to protect key components of each seismic isolation module 100 disposed between the upper bracket 11 and the lower bracket 81, such as the upper cover 20, the upper holder 30, the multiple outer horizontal springs 51, the multiple inner horizontal springs 52, the lower holder 60, the outer vertical spring 71, and the inner vertical spring 72, from external impact.

The lower support 82 is formed in a U-shaped steel with an open lower side and is disposed between the lower bracket 81 and the bottom surface 300 such that two flanges of the lower support 82 are located at the front and rear sides. Two bolt holes are formed on the left and right sides of the web of the lower support 82 to penetrate the web in the thickness direction. The two bolts 61 pass through the left and right bolt holes formed on the web of the lower support 82 and the left and right bolt holes formed on the web of the lower bracket 81 in sequence and then are fastened to the left and right bolt holes of the lower holder 60, and thereby the lower holder 60 and the lower bracket 81 are tightly coupled to the lower support 82. The left and right bolt holes of the lower holder 60 have nut threads formed on the inner peripheral surface thereof such that the two bolts 61 may be fastened.

On the flanges on both sides of the lower support 82, wing plates are formed that are extended by being bent at a right angle outward from the flanges on both sides. A bolt hole penetrating in the thickness direction is formed on each of the wing plates on both sides of the flanges of the lower support 82. The two bolts 102 pass through the bolt holes of the wing plate on the flanges on both sides of the lower support 82, and then are fastened to two anchors 101 embedded in a concrete layer under the floor surface 300, and thereby the wing plates on the flanges on both sides of the lower support 82 are tightly coupled to the floor surface 300. Each of the two anchors 101 has a bolt hole having a nut thread formed on the inner peripheral surface thereof such that the two bolts 102 may be fastened.

The center shaft 90 has a lower end fixed to the center of the lower holder 60, that is, to the center of the bottom surface of the center groove 603, and is disposed vertically with a structure which passes through the inner vertical spring 72, the outer vertical springing 71, and the upper holder 30 in sequence. As illustrated in FIGS. 2 to 4, the center shaft 90 is formed in the shape of a countersunk bolt, and the center hole of the lower holder 60 is formed in a shape in which a diameter of the center hole narrows from the bottom to the top and then becomes constant. The center shaft 90 is inserted into the center hole of the lower holder 60 from the bottom, and the countersunk portion corresponding to the lower end of the center shaft 90 is fitted into the center hole of the lower holder 60, thereby being fixed to the center of the lower holder 60. After the plate head portion of the center shaft 90 is fitted into the center hole of the lower holder 60, the upper surface of the web of the lower bracket 81 is tightly coupled to the lower surface of the lower holder 60 such that the center hole of the lower holder 60 is shielded, and the center shaft 90 may be stably fixed to the center of the lower holder 60.

In this way, after the countersunk portion corresponding to the lower end of the center shaft 90 is fitted into the center hole of the lower holder 60, the threaded body portion of the center shaft 90 penetrates the inner vertical springing 72. After penetrating the inner vertical springing 72, the threaded body portion of the center shaft 90 penetrates the upper portion of the outer vertical spring 71 exposed from the upper end of the inner vertical springing 72. After penetrating the upper portion of the outer vertical spring 71, the threaded body portion of the center shaft 90 penetrates the center hole of the upper holder 30. In this state, the end portion of the countersunk bolt corresponding to the upper end of the center shaft 90 protrudes from the center hole of the upper holder 30. By fastening a nut to the end of the countersunk bolt protruding from the center hole of the upper holder 30, the center shaft 90 may be disposed vertically in a structure that passes through the inner vertical spring 72, the outer vertical spring 71, and the upper holder 30 in sequence.

When the outer vertical spring 71 and the inner vertical spring 72 are bent due to an external impact such as an earthquake, a large electric power equipment such as a distributing board may tilt and fall over. The center shaft 90 having the lower end fixed to the center of the lower holder 60 and is disposed vertically with a structure that passes through the inner vertical spring 72, the outer vertical spring 71, and the upper holder 30 in sequence, may prevent the outer vertical spring 71 and the inner vertical spring 72 from being bent due to an external impact such as an earthquake, and as a result, the electric power equipment may be prevented from falling over due to an external impact such as an earthquake.

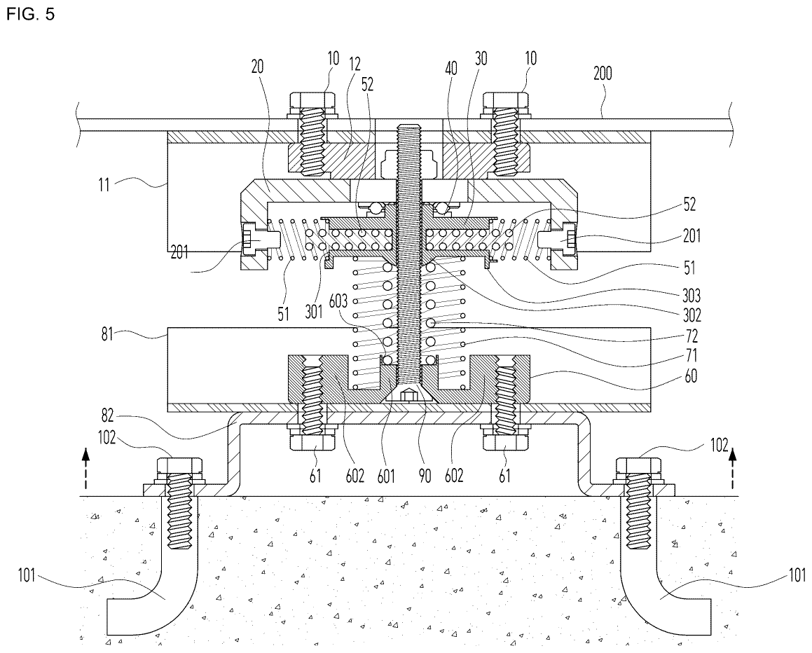

FIG. 5 is a view illustrating the outer vertical spring 71 of FIGS. 2 to 4 in the compressed state. Referring to FIG. 5, when the floor surface 300 rises during vibration of the floor surface 300 due to an earthquake, surrounding construction work, or so on, the vertical gap between the upper holder 30 and the lower holder 60 narrows. As the vertical gap between the upper holder 30 and the lower holder 60 narrows, the outer vertical spring 71 is compressed. When the floor surface 300 descends while the outer vertical spring 71 is compressed, the vertical gap between the upper holder 30 and the lower holder 60 widens, and as the vertical gap between the upper holder 30 and the lower holder 60 widens, the outer vertical spring 71 is expanded. As the compression and expansion of the outer vertical spring 71 are repeated, a weak vibration component in the z-axis direction among the vibrations of the bottom surface 300 may be blocked from being transmitted to the housing 200.

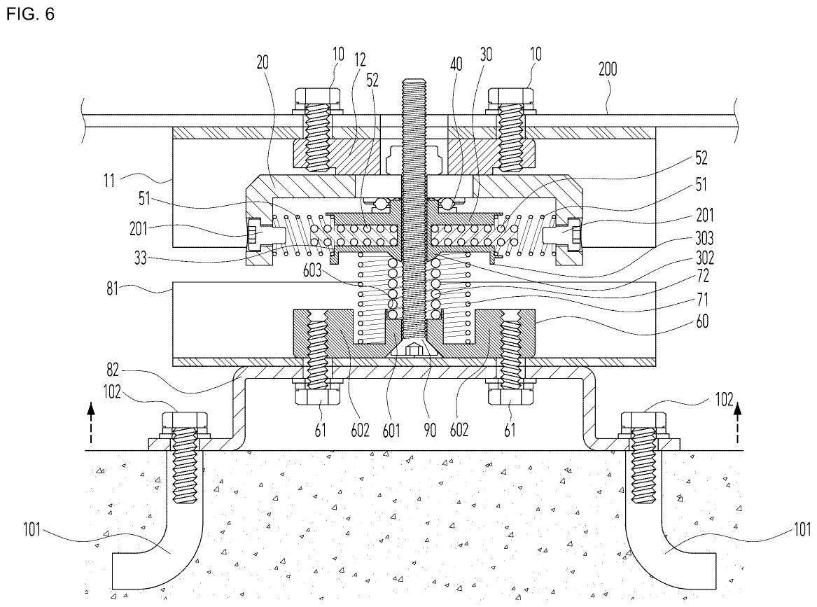

FIG. 6 is a view illustrating the inner vertical spring 72 of FIGS. 2 to 4 in the compressed state. FIG. 6 illustrates a state where the vertical gap between the upper holder 30 and the lower holder 60 is narrowed until the upper end of the inner vertical spring 72 comes into contact with the lower dome portion 302 of the upper holder 30. Referring to FIG. 6, when the bottom surface 300 is further raised in the state illustrated in FIG. 5, the vertical gap between the upper holder 30 and the lower holder 60 gets narrower and the inner vertical spring 72 begins to be compressed. When the floor surface 300 is lowered while the inner vertical spring 72 is compressed, the vertical gap between the upper holder 30 and the lower holder 60 widens, and as the vertical gap between the upper holder 30 and the lower holder 60 widens, the inner vertical spring 72 expands.

In this way, as the inner vertical spring 72 is repeatedly compressed and expanded according to the change in the vertical gap between the upper holder 30 and the lower holder 60 due to the vertical vibration of the floor surface 300, a strong vibration component in the z-axis direction among the vibrations of the floor surface 300 may be blocked from being transmitted to the housing 200. According to the present embodiment, as the inner vertical spring 72 and the outer vertical spring 71 are compressed and expanded together, the intensity range of the vibration component in the z-axis direction that each seismic isolation module 100 may absorb may be expanded.

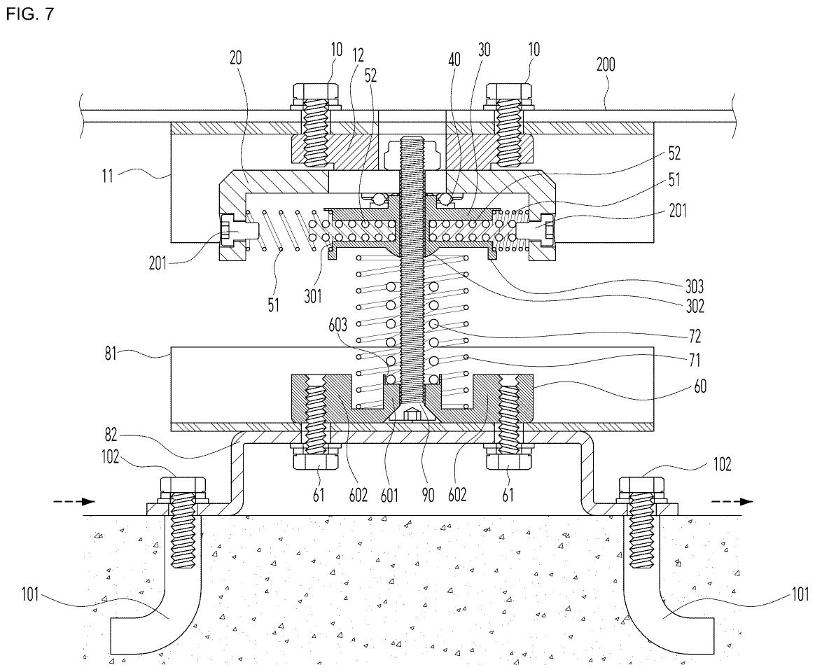

FIG. 7 is a view illustrating the right outer horizontal spring 51 of FIGS. 2 to 4 in the compressed state. Referring to FIG. 7, when the floor surface 300 moves to the right during a vibration process of the floor surface 300 due to an earthquake, surrounding construction, or so on, the left gap between the inner peripheral surface of the upper cover 20 and the outer peripheral surface of the upper holder 30 widens and at the same time, the right gap narrows. As the left gap between the inner peripheral surface of the upper cover 20 and the outer peripheral surface of the upper holder 30 widens, the left outer horizontal spring 51 expands and at the same time, the right outer horizontal spring 51 is compressed as the right gap between the inner peripheral surface of the upper cover 20 and the outer peripheral surface of the upper holder 30 narrows. The left outer horizontal spring 51 has to be designed in length such that the left outer horizontal spring 51 does not fall off in a state where the left gap between the inner peripheral surface of the upper cover 20 and the outer peripheral surface of the upper holder 30 is maximized.

In a state where the left outer horizontal spring 51 is expanded and the right outer horizontal spring 51 is compressed, when the bottom surface 300 moves to the left, the left gap between the inner peripheral surface of the upper cover 20 and the outer peripheral surface of the upper holder 30 narrows and at the same time, the right gap widens. As the left gap between the inner peripheral surface of the upper cover 20 and the outer peripheral surface of the upper holder 30 narrows, the left outer horizontal spring 51 is compressed and as the right gap between the inner peripheral surface of the upper cover 20 and the outer peripheral surface of the upper holder 30 widens, the right outer horizontal spring 51 is expanded. As the compression and expansion of the left and right outer vertical springs 71 are repeated, a weak vibration component in the x-axis direction among the vibrations of the bottom surface 300 may be blocked from being transmitted to the housing 200.

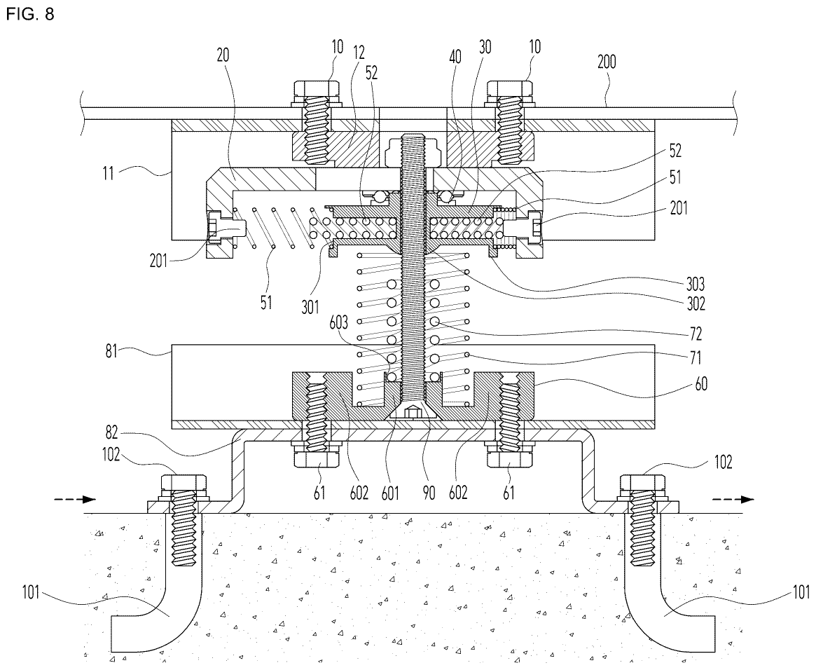

FIG. 8 is a view illustrating the right inner horizontal spring 52 of FIGS. 2 to 4 in the compressed state. FIG. 8 illustrates a state where the right gap between the inner peripheral surface of the upper cover 20 and the outer peripheral surface of the upper holder 30 narrows until the upper end of the right inner horizontal spring 52 comes into contact with the right horizontal protrusion 201 of the upper cover 20. Referring to FIG. 8, when the bottom surface 300 moves further to the right in the state illustrated in FIG. 7, the right gap between the inner peripheral surface of the upper cover 20 and the outer peripheral surface of the upper holder 30 gets narrower and the right inner horizontal spring 52 begins to be compressed. In a state where the right inner horizontal spring 52 is compressed, when the bottom surface 300 moves to the left, the right gap between the inner peripheral surface of the upper cover 20 and the outer peripheral surface of the upper holder 30 widens, and as the right gap between the inner peripheral surface of the upper cover 20 and the outer peripheral surface of the upper holder 30 widens, the right inner horizontal spring 52 expands.

In this way, as the right inner horizontal spring 52 is repeatedly compressed and expanded according to the change in the horizontal gap between the inner peripheral surface of the upper cover 20 and the outer peripheral surface of the upper holder 30 due to the horizontal vibration of the bottom surface 300, a strong vibration component in the x-axis direction among the vibrations of the bottom surface 300 may be blocked from being transmitted to the housing 200. According to the present embodiment, as the right inner horizontal spring 52 and the right outer vertical spring 51 are compressed and expanded together, the intensity range of the vibration component in the x-axis direction that each seismic isolation module 100 may absorb may be expanded.

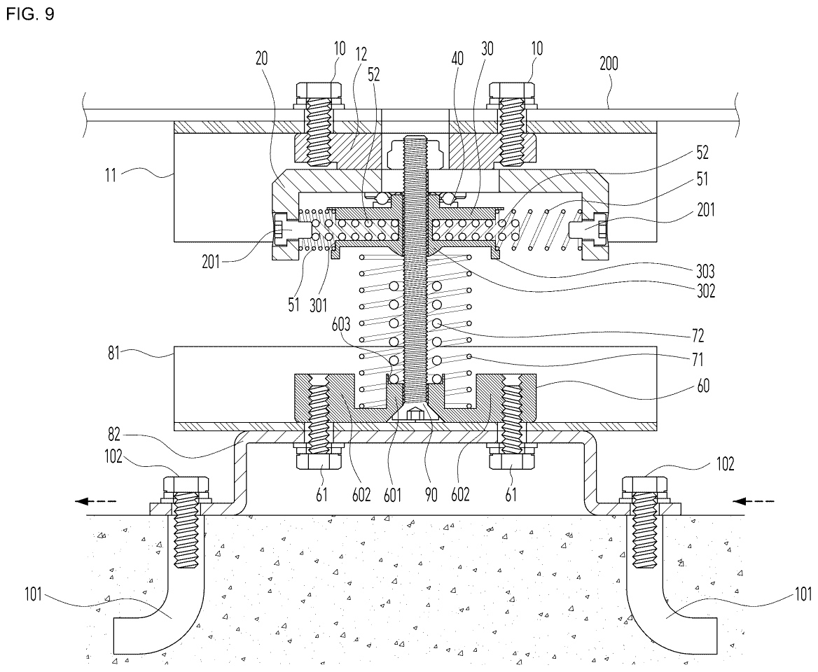

FIG. 9 is a view illustrating the left outer horizontal spring 51 of FIGS. 2 to 4 in compressed state. Referring to FIG. 9, when the floor surface 300 moves to the left during a vibration process of the floor surface 300 due to an earthquake, surrounding construction, or so on, the left gap between the inner peripheral surface of the upper cover 20 and the outer peripheral surface of the upper holder 30 narrows and at the same time, the right gap widens. As the left gap between the inner peripheral surface of the upper cover 20 and the outer peripheral surface of the upper holder 30 narrows, the left outer horizontal spring 51 is compressed and at the same time, as the left gap between the inner peripheral surface of the upper cover 20 and the outer peripheral surface of the upper holder 30 widens, the right outer horizontal spring 51 is expanded. The right outer horizontal spring 51 has to be designed such that the right outer horizontal spring 51 does not fall off in a state where the right gap between the inner peripheral surface of the upper cover 20 and the outer peripheral surface of the upper holder 30 is maximized. The length of the other outer horizontal spring 51 must also be designed similarly.

In a state where the left outer horizontal spring 51 is compressed and the right outer horizontal spring 51 is expanded, when the bottom surface 300 moves to the right, the left gap between the inner peripheral surface of the upper cover 20 and the outer peripheral surface of the upper holder 30 widens and at the same time, the right gap narrows. As the left gap between the inner peripheral surface of the upper cover 20 and the outer peripheral surface of the upper holder 30 widens, the left outer horizontal spring 51 expands and as the right gap between the inner peripheral surface of the upper cover 20 and the outer peripheral surface of the upper holder 30 narrows, the right outer horizontal spring 51 is compressed. As the compression and expansion of the left and right outer vertical springs 71 are repeated, a weak vibration component in the x-axis direction among the vibrations of the bottom surface 300 may be blocked from being transmitted to the housing 200.

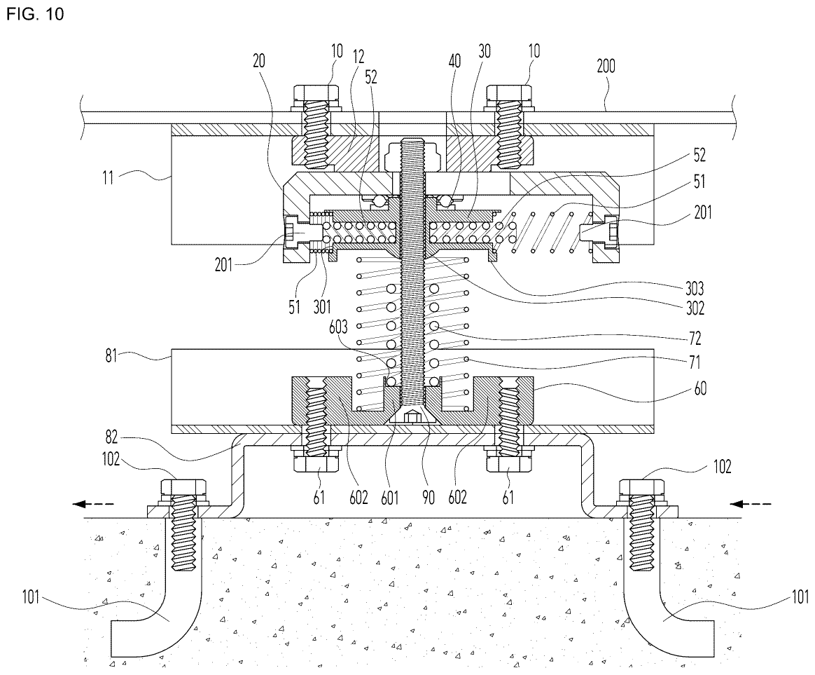

FIG. 10 is a view illustrating the left inner horizontal spring 52 of FIGS. 2 to 4 in the compressed state. FIG. 10 illustrates a state where the left gap between the inner peripheral surface of the upper cover 20 and the outer peripheral surface of the upper holder 30 is narrowed until the upper end of the left inner horizontal spring 52 comes into contact with the left horizontal protrusion 201 of the upper cover 20. Referring to FIG. 10, when the bottom surface 300 moves further to the left in the state illustrated in FIG. 9, the left gap between the inner peripheral surface of the upper cover 20 and the outer peripheral surface of the upper holder 30 gets narrower and the left inner horizontal spring 52 begins to be compressed. In a state where the left inner horizontal spring 52 is compressed, when the bottom surface 300 moves to the right, the left gap between the inner peripheral surface of the upper cover 20 and the outer peripheral surface of the upper holder 30 widens, and as the right gap between the inner peripheral surface of the upper cover 20 and the outer peripheral surface of the upper holder 30 widens, the left inner horizontal spring 52 expands.

In this way, as the horizontal gap between the inner peripheral surface of the upper cover 20 and the outer peripheral surface of the upper holder 30 changes due to the horizontal vibration of the bottom surface 300, the compression and expansion of the left inner horizontal spring 52 are repeated, such that a strong vibration component in the x-axis direction among the vibrations of the bottom surface 300 may be blocked from being transmitted to the housing 200. According to the present embodiment, as the left inner horizontal spring 52 and the left outer vertical spring 51 are compressed and expanded together, the intensity range of the vibration component in the x-axis direction that each seismic isolation module 100 may absorb may be expanded.

Likewise, as the front and rear outer horizontal springs 51 are repeatedly compressed and expanded, a weak vibration component in the y-axis direction among the vibrations of the floor surface 300 may be blocked from being transmitted to the housing 200, and as the front inner horizontal spring 52 or the rear inner horizontal spring 52 is repeatedly compressed and expanded, a strong vibration component in the y-axis direction among the vibrations of the floor surface 300 may be blocked from being transmitted to the housing 200. The outer vertical spring 71 may bend due to the horizontal vibration applied to each seismic isolation module 100, but in order to help understand the present embodiment, ideal forms in which the upper holder 30 and the lower holder 60 behave in the same manner with respect to the horizontal vibration are illustrated in FIGS. 6 to 9.

According to the present embodiment as described above, vertical vibrations of various intensities may be absorbed by the interlocking vibration absorption structure of the outer vertical spring 71 and the inner vertical spring 72, and horizontal vibrations of various intensities may be absorbed by the interlocking vibration absorption structure of the four outer horizontal springs 51 and the four inner horizontal springs 52, such that various three-dimensional omnidirectional vibrations whose intensities are distributed over a wide range may be absorbed smoothly.

The present disclosure has been described with reference to preferred embodiments thereof. Those skilled in the art will appreciate that the present disclosure may be implemented in modified forms without departing from the essential characteristics of the present disclosure. Therefore, the disclosed embodiments should be considered from an illustrative rather than a restrictive perspective. The scope of the present disclosure is indicated by the claims, not the foregoing description, and all differences within the scope equivalent thereto should be interpreted as being included in the present disclosure.

What is claimed is:

1. A seismic isolation apparatus for electric power equipment, comprising:
an upper holder (30) disposed below a lower surface of a housing (200) in which multiple electric power devices are stored;
a lower holder (60) disposed above a floor surface (300) of a space where the housing (200) is installed;
an outer vertical spring (71) formed in a form of a compression coil spring and disposed vertically between the upper holder (30) and the lower holder (60) to be compressed or expanded according to a change in a vertical gap between the upper holder (30) and the lower holder (60);
an inner vertical spring (72) formed in a form of a compression coil spring having an elastic coefficient greater than that of the outer vertical spring (71) and a diameter smaller than that of the outer vertical spring (71), and disposed vertically between the upper holder (30) and the lower holder (60) with a structure inserted into an inside of the outer vertical spring (71) to be compressed or expanded according to the change in the vertical distance between the upper holder (30) and the lower holder (60); and
a center shaft (90) of which a lower end is fixed to a center of the lower holder (60) and disposed vertically with a structure that passes through the inner vertical spring (72), the outer vertical spring (71), and the upper holder (30) in sequence.

2. The seismic isolation apparatus for electric power equipment of claim 1, wherein
a lower dome portion (302) is formed on a lower surface of the upper holder (30) in a dome shape, a height of which increases in the vertical direction toward the lower holder (60) as going toward the center, and
an upper end of the inner vertical spring (72) comes into contact with the lower dome portion (302) during a process in which the outer vertical spring (71) is compressed as a vertical gap between the upper holder (30) and the lower holder (60) narrows, and after the upper end of the inner vertical spring (72) comes into contact with the lower dome portion (302), when the vertical gap between the upper holder (30) and the lower holder (60) gets narrower, the inner vertical spring (72) begins to be compressed.

3. The seismic isolation apparatus for electric power equipment of claim 2, wherein
a circular rail (303) is formed on the lower surface of the upper holder (30) in a form that surrounds the lower dome portion (302), and
an upper end of the outer vertical spring (71) is fitted into a groove between the lower dome portion (302) and the circular rail (303) on the lower surface of the upper holder (30), and an upper end of the inner vertical spring (72) is located to be spaced apart from the lower dome portion (302) in a state where the outer vertical spring (71) is expanded.

4. The seismic isolation apparatus for electric power equipment of claim 3, wherein
a center protrusion (601) that protrudes in the vertical direction toward the upper holder (30) in a shape of a circular plate, and an outer protrusion (602) that protrudes in a form surrounding the center protrusion (601) are formed on an upper surface of the lower holder (60), and
a lower end of the outer vertical spring (71) is fitted into a groove between the center protrusion (601) and the outer protrusion (602), and a lower end of the inner vertical spring (72) is fitted into a center groove (603) formed on an upper surface of the center protrusion (601).

5. The seismic isolation apparatus for electric power equipment of claim 1, further comprising:
an upper cover (20) formed in a cross-section of “[” shape that is open at the lower side; and
multiple outer horizontal springs (51) that are each formed in a form of a compression coil spring and are disposed in the horizontal direction between the upper cover (20) and the upper holder (30) to be compressed or expanded according to a change in a horizontal gap between the upper cover (20) and the upper holder (30),
wherein the upper holder (30) is formed in a cylindrical shape and is disposed in an inner space of the upper cover (20).

6. The seismic isolation apparatus for electric power equipment of claim 2, further comprising:
multiple inner horizontal springs (52) that are each formed in a form of a compression coil spring having an elastic coefficient greater than that of each outer horizontal spring (51) and a diameter smaller than that of each outer horizontal spring (51), and is disposed between the upper cover (20) and the upper holder (30) in horizontal direction with a structure that is inserted into the inside of each of the multiple outer horizontal springs (51) to be compressed or expanded according to a change in a horizontal gap between the upper cover (20) and the upper holder (30).

7. The seismic isolation apparatus for electric power equipment of claim 3, wherein
multiple horizontal protrusions (201) are formed on an inner surface of the upper cover (20) at regular intervals to protrude in the horizontal direction toward the upper holder (30), and
one end of at least one inner horizontal spring (52) comes into contact with the at least one horizontal protrusion (201) during a process in which at least one outer horizontal spring (51) among the multiple outer horizontal springs (51) and is compressed as a gap between at least one horizontal protrusion (201) among the multiple horizontal protrusions (201) and the upper holder (30) narrows, after one end of the at least one inner horizontal spring (52) comes into contact with the at least one horizontal protrusion (201), when a gap between the at least one horizontal protrusion (201) and the upper holder (30) gets narrower, the at least one inner vertical spring (72) begins to be compressed.

8. The seismic isolation apparatus for electric power equipment of claim 7, wherein one end of each of the multiple outer horizontal springs (51) is fitted around each of the multiple horizontal protrusions (201), and one end of each of the multiple inner vertical springs (72) is located to be spaced apart from each of the multiple horizontal protrusions (201) in a state where each of the multiple outer horizontal springs (51) is expanded.

9. The seismic isolation apparatus for electric power equipment of claim 8, wherein
multiple stepped grooves (301) are formed on an outer surface of the upper holder (30), each of which has an outer groove that is sunken opposite to the direction toward each of the multiple horizontal protrusions (201) and an inner groove in a form that bottom surface center of the outer groove is sunken, and
the other end of each of the multiple outer horizontal springs (51) is fitted into the outer groove of each of the multiple step grooves (301), and the other end of each of the multiple inner horizontal springs (52) is fitted into the inner groove of each of the multiple step grooves (301).

10. The seismic isolation apparatus for electric power equipment of claim 5, further comprising:
a ball slider 40 that horizontally slides in a state of coming into contact with an inner surface of the upper cover (20), using multiple balls that make rolling motions by coming into contact with a lower surface of the upper cover (20),
wherein the ball slider (40) is attached to the upper surface of the upper holder (30) to allow the upper holder (30) to slide horizontally inside the upper cover (20) according to the compression or expansion of the multiple outer horizontal springs (51).

11. The seismic isolation apparatus for electric power equipment of claim 1, wherein
a center hole is formed in the center of the lower holder (60), such that a diameter of the center hole gets narrower toward an upper side of the center hole, and
the center shaft (30) is formed in the shape of a countersunk bolt and a countersunk portion corresponding to a lower end is fitted into the center hole such that the center shaft (30) is fixed to the center of the lower holder (60).

12. An earthquake-proof distributing board comprising:
a housing (200) in which multiple distribution devices are stored; and
the seismic isolation apparatus for electric power equipment of claim 1, which is installed between the lower surface of the housing (200) and the floor surface (300) of the space in which the housing (200) is installed.
